(19) United States
(12) Patent Application Publication
(10) Pub. No.: US 2013/0196305 A1
(43) Pub. Date: Aug. 1, 2013

(54) METHOD AND APPARATUS FOR GENERATING QUESTIONS

(71) Applicants: Allon Adir, Kiryat Tivon (IL); Itai Jaeger, Lavon (IL); Ronen Levy, Haifa (IL); Tamer Salman, Haifa (IL)

(72) Inventors: Allon Adir, Kiryat Tivon (IL); Itai Jaeger, Lavon (IL); Ronen Levy, Haifa (IL); Tamer Salman, Haifa (IL)

(73) Assignee: International Business Machines Corporation, Armonk, NY (US)

(21) Appl. No.: 13/360,808

(22) Filed: Jan. 30, 2012

(51) Int. Cl. G09B 3/00

(52) U.S. Cl. 434/322

(57) ABSTRACT

A computer-implemented method and apparatus for generating questions. The method comprises receiving a rule; dynamically generating a graph representing a question, the graph comprising one or more nodes, each node associated with a rule having one or more variables; sampling a value from the value domain for the variable; and synthesizing a textual representation of the graph.

### TECHNICAL FIELD

The present disclosure relates to generating questions in a particular subject in general, and to a rule based method and apparatus for automatic and dynamic generation of questions.

### BACKGROUND

Practicing is an important part in studying any new subject. Solving questions may constitute an important part of any learning process, whether it involves frontal teaching, self study, group study or any other method.

Teachers, tutors, teaching program developers or other personnel involved with teaching or training may be required to generate a large number of questions, in order to enable students of all levels to experience with as many aspects as possible of the taught subject.

Questions may be required for ongoing exercising, homework, class assignments, tests, test simulation, or the like.

However, generating a large and varied collection of questions, comprising questions that cover all aspects of the subject and all difficulty levels is a non-trivial task.

Manual test generation may be labor intensive and time consuming, and requires imagination, planning, careful proof reading and testing. Also, after a while questions composed by one person tend to repeat themselves and become less effective.

Preparing a question bank and selecting questions therefrom has drawbacks related to the question bank being finite, static and subject to leakage, cheating, and intrusion. In addition, the selection process may also pose a number of shortcomings such as limited control over the difficulty and diversity of the questions, as well as the possibility of repetition,

Other solutions include generating a bank of question templates or predefined formats, and generating questions upon the templates. A question template is a question with domains instead of numerical values. In order to use a template question for generating questions at a later stage, the template has to be stored and then retrieved. Then once a question template is chosen, a question can be generated by substituting numerical values into the template from the given domains. These solutions also suffer from a finite number of templates and limited control over difficulty and diversity of the questions, as well as the risks of repetition, leakage, and intrusion.

### BRIEF SUMMARY

One exemplary embodiment of the disclosed subject matter is a computer-implemented method performed by a computerized device, comprising: receiving a rule; dynamically generating a graph representing a question, the graph comprising one or more nodes, each node associated with a rule having one or more variables; sampling a value from the value domain for one or more of the variable; and synthesizing a textual representation of the graph.

Another exemplary embodiment of the disclosed subject matter is an apparatus having a processing unit and a storage device, the apparatus comprising: a receiving component for receiving a rule; a graph generator for dynamically generating a graph representing a question, the graph comprising one or more nodes, each node associated with a rule having one or more variables; a value sampling component for sampling a value from the value domain for one or more of the variables; and a text synthesizing component for synthesizing a textual representation of the graph.

Yet another exemplary embodiment of the disclosed subject matter is a computer program product comprising: a non-transitory computer readable medium; a first program instruction for receiving a rule; a second program instruction for dynamically generating a graph representing a question, the graph comprising one or more nodes, each node associated with a rule having one or more variables; and a third program instruction for sampling a value from the value domain for the one o more of the variables; and wherein said first, second, and third fourth program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart of steps in a method for automatic question generation, in accordance with some exemplary embodiments of the disclosed subject matter;

FIG. 2A shows a schematic illustration of the graph constructing step of generating a question, in accordance with some exemplary embodiments of the disclosed subject matter;

FIG. 2B shows a schematic illustration of the domain propagation step of generating a question, in accordance with some exemplary embodiments of the disclosed subject matter;

FIG. 2C shows a schematic illustration of the graph sampling step of generating a question, in accordance with some exemplary embodiments of the disclosed subject matter; and

FIG. 3 shows a block diagram of components of an apparatus for automatic question generation, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block or blocks of block diagrams.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the need to create random questions for a given field, based on rules in the field. Using current techniques, questions are generated manually, selected from a question bank, generated by filling details into templates, or the like.

Another technical problem is the generation of questions with controllable level of difficulty, diversity, and length or complexity.

Yet another technical problem is the need to generate accompanying additions to a question, such as a solution to the question, hints for solving, a tool for checking a user's solution, multiple choice questions, prove or prove-wrong questions, or the like.

One technical solution comprises the automatic generation of questions, given a field and rules within the field. A field can be, for example, a scientific discipline a student is expected to study and master. Each field may be associated with objects. For example, in kinematics the objects may be a car, a train, a person, a fly, or the like. The field may also be associated with relevant entities, wherein each entity may have a name, a symbol, objects with which it may be associated, value range or domain, or the like. In the kinematics example, entities may include velocity having a symbol v, and which may be associated with a car, a train, a person, a fly, or the like. Other entities may include distance, time, time difference, or others.

Each object may be associated with a multiplicity of entities, and each entity may be associated with a multiplicity of objects.

Each rule in the field may describe some relation between entities. For example kinematics contains the rule x=v*t which indicates that the distance traveled in constant velocity equals the velocity multiplied by the travel time. A rule is generally not associated with a particular object, so that a multiplicity of objects may be associated with each rule. However, in some disciplines, objects may not be required. For example, in the field of abstract trigonometry, questions may include equalities or inequalities to be proved or refuted, without associated objects.

The collection which includes the field, rules, entities and optionally the objects may be referred to as a model.

Given a request to generate a question of a specific field, a graph is constructed. The root of the graph relates to a rule from the field, such as x=v*t, wherein one or more of the variables x, v or t is indicated as unknown, and the others are indicated as either given or derived. For each derived variable, a child node is generated which relates to the same rule or to another rule, in which the variable is the unknown. The process may continue until a node is generated for each derived variable, in which all other variables are given.

Some nodes may make use of ad-hoc rules which are relevant only to the question, and are not generally a part of the discipline. For example, an ad-hoc rule may indicate that the velocity of the train is double the velocity of the car.

The difficulty of the generated question may depend upon the number of nodes, the width of the graph, the depth of the graph, an optional difficulty indication of each of the rules associated with nodes in the graph, the unknown variable within each node, or the like.

Once the graph is constructed, objects are selected for each node, such that the object is associated with the variables of the rule. In the example above, the rule x=v*t may be associated with a car or a train, but not with a tree.

When the objects are selected, the domains for the various variables are indicated and propagated throughout the graph. A domain may include one or more values, a value range, or the like. For example a mass must be positive, a car velocity may be between 0 and 200 km/h, or the like. The domain may also be associated with additional limitations, such as an integer number dividable by 10, or the like. These limitations may be derived from the particular field, associated with the difficulty or convenience of the question, or other causes.

After domain propagation, domain projection may be performed, which projects the domains from the root node of the graph to other nodes. For example if the velocity of a car is in the range of 10 km/h-150 km/h, the velocity of the train in the example above (in which the velocity of the train is double the velocity of the car) is 20 km/h-300 km/h. Combining this range with the general velocity domain for a train, being for example 10 km/h-200 km/h, yields a domain of 20 km/h-200 km/h.

Once the domains are projected, value selection may be performed, which starts by selecting values for the given variables in the leaves of the graph. The values are randomly selected from the relevant domains. The nodes are then resolved from the leaves towards the root, such that in each node the given variables are assigned values, and the unknown variables are determined. The values of the unknown variables are then used as derived variables in parent nodes for determining further unknown variables. The process stops at the root of the graph, at which the first unknown which is the solution to the question is assigned a value.

Then, using a natural language engine, a textual representation is synthesized for the graph, which includes the graph construct, the concrete values for the given variables, and language information available for the variables and objects. The question phrase is constructed from the node of the graph that includes the main unknown of the question, usually the root node.

One technical effect of the disclosed subject matter relates to a method and apparatus for randomly and dynamically generating questions in a required field. Given the rules relevant for the field, an endless number of questions can be generated. Unlike prior art solutions, since the question is generated dynamically, no template has to be created and stored.

Another technical effect of the disclosed subject matter relates to generating questions having a required difficulty degree. The difficulty degree depends on a multiplicity of controllable parameters, such as the depth or width of the graph, the rules, the unknown variable in a rule or others, and can thus be adjusted.

Yet another technical effect of the disclosed subject matter relates to generating additional products, such as a school solution for a question, hints for the solution, dynamic help for a person solving the question, a multiple choice question, a prove or prove wrong question or the like.

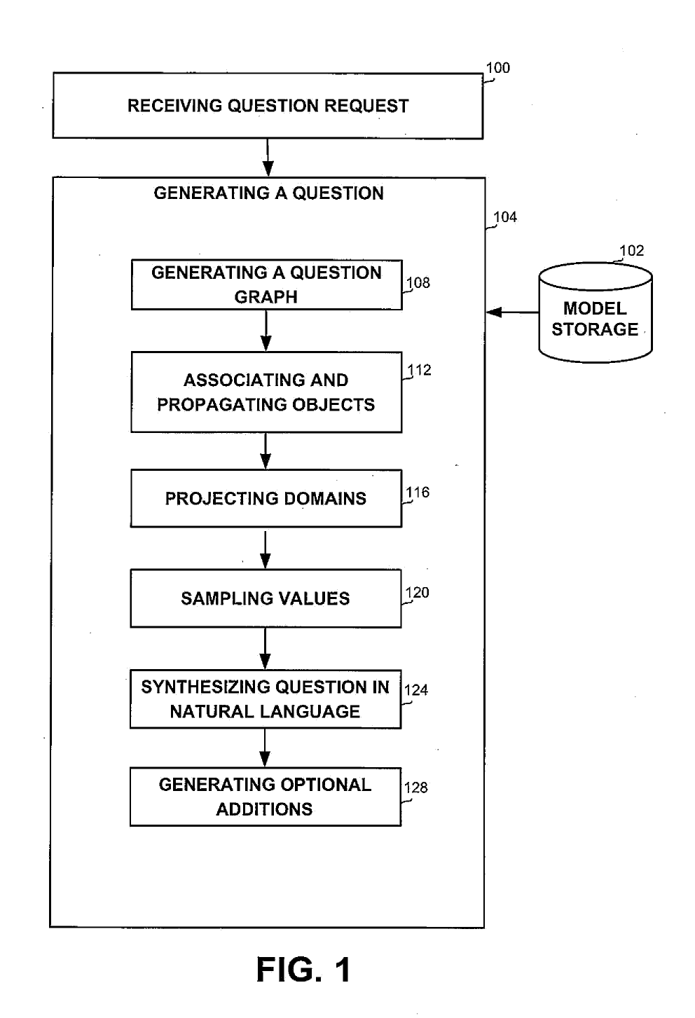

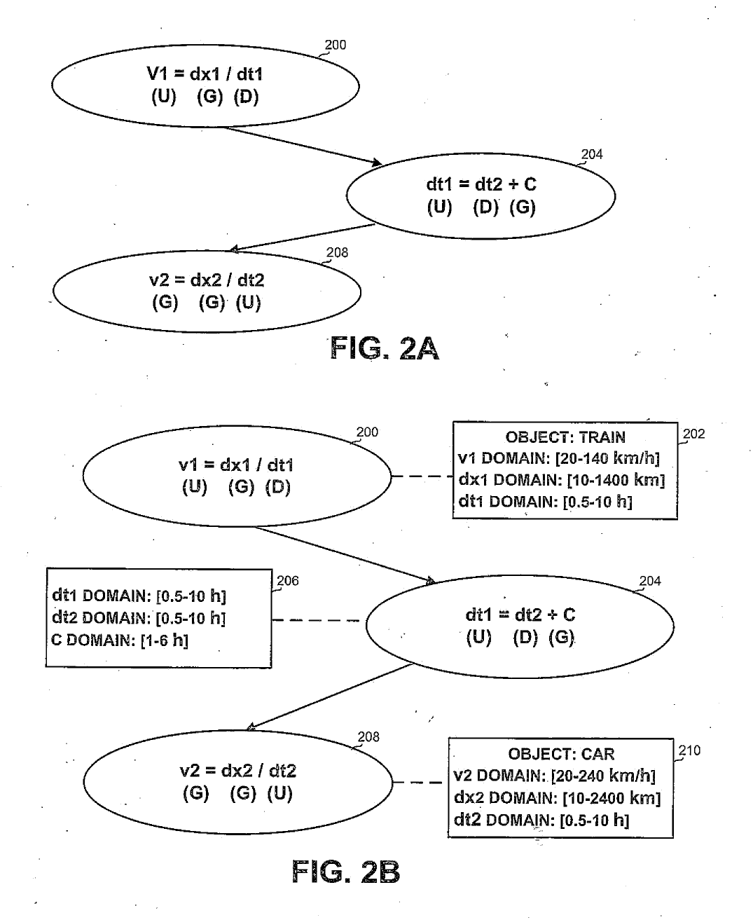

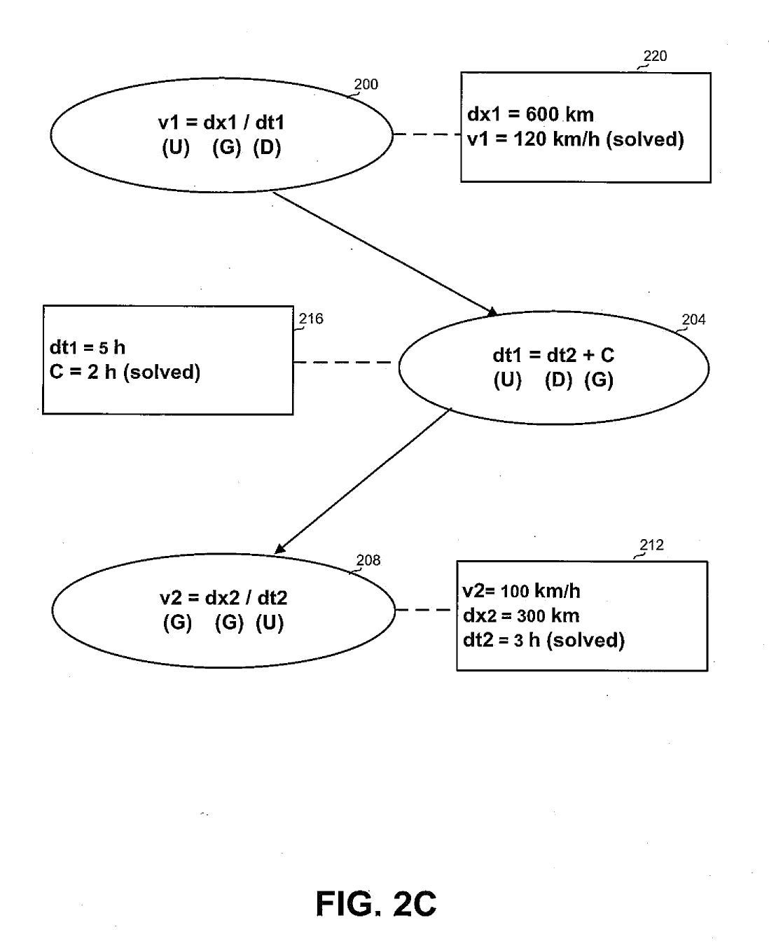

Referring now to FIG. 1, showing a flowchart of steps in a method for automatic question generation, and to FIGS. 2A, 2B and 2C demonstrating specific steps.

On step 100 a request for generating a question is received. The request may indicate the field of the question, and may further indicate a specific rule the question should relate to. The request may also indicate a required difficulty degree for the question, or other information, such as a information concerning the desired question, e.g. “ask about velocity?” or the like.

On step 104, the question is generated, which may include the substeps detailed below. The question generation may use model information related to the field, rules, objects or the like from model storage 102, as well as the information provided with the question generation request.

The model includes rules which may also be associated with difficulty and complexity degrees; objects that may be used in generating questions, such as a person, a car, a stone, or the like; entities, such as physical measures for example size, velocity, mass, or the like; rules associating entities; and allowed domains for each entity, which may or may not be related to an object, for example a mass is always positive, but in a context of a person may be limited to 40-150 kg. The model may further include information concerning the correct way a rule, object or entity should be addressed textually.

On substep 108, a question graph may be generated. This substep is exemplified in FIG. 2A showing a schematic illustration of a question graph. The graph may be a directed acyclic graph, starting at a root node. The root node may be associated with the specific rule provided with the request, a rule randomly chosen from the field, or the like.

One of the variables in the rule is selected to be the unknown of the question, while the other variables may be selected to be either given or derived. This choice should be a result of the difficulty and complexity constraints. The rule selected for root node 200 of the exemplary graph of FIG. 2A is the kinematics velocity rule: v=dx/dt, wherein due to the required difficulty level an index has been added to the variables, since another node with other instances of the rule will be involved. One variable of the rule, being the velocity v1 is selected to be unknown, while another variable being the displacement dx1 is selected to be given, and a third variable dt1 is selected to be derived, such that its value will have to be resolved from another node. A child node is then generated for each derived variable, wherein the child node is associated with another rule that involves the same entity. The rule may be a global rule from the model, or a local rule, which may also be referred to as an ad-hoc rule. In the example of FIG. 2A, node 204 is generated for resolving dt1, wherein node 204 relates to a local rule of dt1=dt2+C. C is selected to be given, and dt2 is selected to be derived, which in turn causes the generation of node 208, relating again to the rule of v=dx/dt as node 200, but with different variables: v2=dx2/dt2. dt2 is the unknown to be resolved, wherein dx2 and v2 are selected to be given.

The difficulty level of the question may be controlled by the size and depth of the generated graph, as well as the difficulty of the rules used in the graph. Thus, the deeper and wider the graph, and the harder rules used, the more difficult questions may be generated. The difficulty level of the question can be evaluated by incorporating all or a part of the longest path in the graph, the number of different paths, the average length of a path in the graph, the difficulty of the used rules, the difficulty of the local rules, the diversity of the used rules, or any other complexity measure.

Once the graph is constructed, on optional substep 112, objects may be associated with the nodes of the graph, in accordance with the rules, by propagating the objects through the graph, for example from the root to the leaves. Thus, in the example of FIG. 2B, as indicated by information box 202, a train is associated with node 200, and a car is associated with node 208 as indicated by information box 210.

It will be appreciated that in some disciplines objects may not be needed, for example in the field of abstract trigonometry, in which the questions can be equalities or inequalities to be proved or refuted, or in cases in which a formula is to be computed. In such cases, objects are not assigned to the rules.

The domains of each variable, whether the node is associated with an object or not, are then projected through the graph. For example, the velocity of the train, being 20-140 km/h, the distance traveled by the train being 10-1400 km, and the travel time of the train being 0.5-10 hours are indicated for node 200, and the velocity of the car being 20-240 km/h, the distance traveled by the car being 10-2400 km, and the travel time of the car being 0.5-10 hours are indicated for node 208. The domains are then propagated towards the local rules which are not associated with objects. In the example of FIG. 2B, the domains of dt1 and dt2 are propagated from nodes 200 and 208, respectively, to node 204.

On substep 116 domains are projected among the nodes. Domain projection may refer to associating sub-domains or otherwise associated domains with objects. For example, assuming that variable C of node 204 is positive of example 1-6 h, then if the domain of t1 is 0.5-10 h, then the domain of t2 must be smaller.

The domains may be projected using a constraint solver, such as a Constraint Satisfaction Problem (CSP) solver, a satisfiability (SAT) solver, or the like. The domain may be associated with an object which may contribute its own constraints on the domain, for example the possible velocity range of a car. However, even if an entity is not associated with an object, it may still require domain definition for example by projection, whether in general or for a specific question or discipline. For example, an angle, although abstract still needs to be in the range of 0 to 2 X pi.

On substep 120, values may be sampled for each given variable in each node, starting at the leaves. The value may be selected from the domain determined on projection substep 116. The nodes can then be processed from the leaves towards the root node, to determine the unknown variables. However, other methods for assigning values may be applied, which may not be associated with domain projection and sampling.

In the example of FIG. 2C, as indicated in information box 212, dx2 is selected to be 300 km, and v2 is selected to be 100 km/h. t2 is thus determined to be 3 h. Continuing to node 204, C is selected to be 2 h, and dt1 determined to be 5 h, as indicated in information box 216. Proceeding to node 200, and selecting dx1 to be 600 km, provides the solution to the unknown v1 to be 120 km/h, as indicated in information box 220.

On substep 124, a question may be synthesized based on the graph, the objects, and the associated values for the given variables. In some embodiments, the question phrase may be constructed from the rule associated with the unknown variable of the root node of the graph. In the example of FIG. 2C the generated question may be phrased as: a car drives a distance of 300 km at velocity of 100 km/h; a train travels 2 hours more than the car; the train travels a distance of 600 km; what is the velocity of the train?

On substep 128, optional additions may be generated. For example, a multiple choice question may be generated which lists the correct answer as well as one or more wrong answers; a “prove” or “prove wrong” question may be generated by providing the correct or an incorrect answer, respectively; a full solution may be provided by tracing the graph from the leaves to the root node and providing text for each node; the user's solution can be checked by following the stages and intermediate results; the question may be divided into subsections and formulated as a multi-section question, or the like.

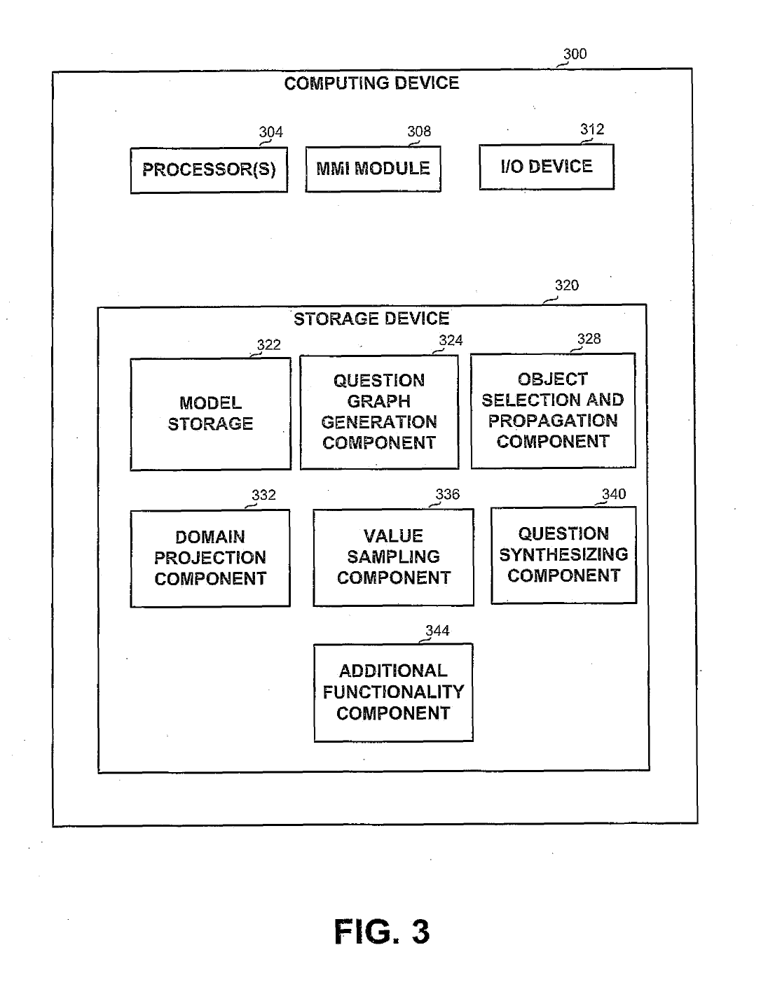

Referring now to FIG. 3, showing a block diagram of components of an apparatus for testing transactions.

The environment comprises a computing device 300, which may comprise one or more processors 304. Any of processors 304 may be a Central Processing Unit (CPU), a microprocessor, an electronic circuit, an Integrated Circuit (IC) or the like. Alternatively, computing device 300 can be implemented as firmware writers for or ported to a specific processor such as digital signal processor (DSP) or microcontrollers, or can be implemented as hardware or configurable hardware such as field programmable gate array (FPGA) or application specific integrated circuit (ASIC). Processors 304 may be utilized to perform computations required by computing device 300 or any of it subcomponents.

In some exemplary embodiments of the disclosed subject matter, computing device 300 may comprise a man machine interface (MMI) module 308. MMI module 308 may be utilized to receive input or provide output to and from the apparatus, for example receiving a request for a question or model-related information, and providing the question or another output.

In some embodiments, computing device 300 may comprise an input-output (I/O) device 312 such as a terminal, a display, a keyboard, an input device or the like to interact with the system, to invoke the system and to receive results. It will however be appreciated that the system can operate without human operation and without I/O device 312.

In some embodiments, computing device 300 may provide an interface for input and output. The interface may be implemented as part of MMI module 308 or separately. The question generation and other operations may be implemented using software components, hardware components, combination thereof, or the like.

Computing device 300 may comprise one or more storage devices 320 for storing executable components, and which may also contain data during execution of one or more components. Storage device 320 may be persistent or volatile. For example, storage device 320 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 320 may retain program code operative to cause any of processors 304 to perform acts associated with any of the steps shown in FIG. 1 above, for example receiving a request, generating a question, or the like.

Storage device 320 may comprise one or more model storage areas 322 for storing one or more models associated with one or more disciplines, such as kinematics, dynamics, various chemistry subjects, trigonometry, algebra, or the like.

The components detailed below may be implemented as one or more sets of interrelated computer instructions, loaded to storage device 320 and executed for example by any of processors 304 or by another processor. The components may be arranged as one or more executable files, dynamic libraries, static libraries, methods, functions, services, or the like, programmed in any programming language and under any computing environment.

In some embodiments the loaded components may include a question graph generation component 324 for generating a question graph as described in association with substep 108 of FIG. 1.

The loaded components may further comprise object selection and domain propagation component 328 for selecting objects to be associated with nodes of the graph, and propagating the object domains throughout the graph, as described in association with substep 112 of FIG. 1.

Another component is domain projection component 332 for projecting the propagated domains throughout the graph, as described in association with substep 116 of FIG. 1.

Yet another component is value sampling component 336 which samples values for the given variables of the leaves of the graph, out of the projected domains, and determines the unknown values throughout the graph to generate a solution, as described in association with substep 120 of FIG. 1.

The loaded components may further comprise question synthesizing component 340 utilizing a natural language engine for generating a textual question based upon the graph with its rules, objects, and given values.

Storage device 320 may also store therein additional functionality component 344 for generating additional products, such as school solution, multiple choice questions, hints, or the like.

The disclosed method and apparatus provide for automatically and dynamically generating questions in a particular field. The questions may be generated in a variety of difficulty levels, and in a variety of forms. In some embodiments, the system may be adapted to work in a personalized mode, in which the performance of an individual user is monitored and the difficulty and complexity of questions are updated according to the user's progress and needs.

The apparatus and method may be used for training, generating assignments, or generating exams for students without much effort on the teachers' side, while eliminating the risks of repetition, exam leakage, cheating, and intrusion. The apparatus and method can also facilitate remote learning and tuition reduction.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a rule;
dynamically generating a graph representing a question, the graph comprising at least one node, the at least one node associated with a rule having at least one variable;
sampling a value from the value domain for the at least one variable; and
synthesizing a textual representation of the graph.

2. The computer-implemented method of claim 1, further comprising:
associating an object with the rule;
propagating a value domain associated with the object through the graph; and
projecting the value domain through the graph.

3. The computer-implemented method of claim 2, wherein the graph comprises at least one root and at least one leaf, and wherein the value domain is propagated from the root to the at least one leaf.

4. The computer-implemented method of claim 2, wherein the graph comprises at least one root and at least one leaf, and wherein the value is propagated from at least one leaf to the root.

5. The computer-implemented method of claim 1, wherein each of the at least one variable of the rule is associated with a status selected from the group consisting of: unknown, derived and given.

6. The computer-implemented method of claim 15, wherein a child of a node in the graph is associated with a variable of a rule associated with the node, the variable having a derived status.

7. The computer-implemented method of claim 1, wherein synthesizing the textual representation comprises natural language synthesis.

8. The computer-implemented method of claim 1, further comprising generating a hint for a question associated with the textual representation.

9. The computer-implemented method of claim 1, further comprising generating an answer for a question associated with the textual representation.

10. The computer-implemented method of claim 1, further comprising checking an answer for a question associated with the textual representation.

11. The computer-implemented method of claim 1, wherein the graph is generated in accordance with a difficulty level.

12. An apparatus having a processing unit and a storage device, the apparatus comprising:
a receiving component for receiving a rule;
a graph generator for dynamically generating a graph representing a question, the graph comprising at least one node, the at least one node associated with a rule having at least one variable;
a value sampling component for sampling a value from the value domain for the at least one variable; and
a text synthesizing component for synthesizing a textual representation of the graph.

13. The apparatus of claim 112, further comprising:
an object selection and domain propagation component for associating an object with the rule and propagating a value domain associated with the object through the graph; and
a value projection component for projecting the value domain through the graph.

14. The apparatus of claim 13, wherein the graph comprises at least one root node and at least one leaf node, wherein the value domain is propagated from the root to the at least one leaf, and wherein the value is propagated from at least one leaf to the root.

15. The apparatus of claim 112, wherein the at least one node is associated with a formula, and wherein each variable of the rule is associated with a status selected from the group consisting of: unknown, derived and given.

16. The apparatus of claim 11215, wherein a child of a node in the graph is associated with a variable of a rule associated with the node, the variable having a derived status.

17. The apparatus of claim 112, wherein the text synthesizing component is a natural language synthesizer.

18. The apparatus of claim 112, further comprising a hint generation component for generating a hint for a question associated with the textual representation.

19. The apparatus of claim 112, further comprising an answer generation component for generating an answer for a question associated with the textual representation.

20. The apparatus of claim 112, further comprising an answer checking component for checking an answer for a question associated with the textual representation.

21. The apparatus of claim 112, wherein the graph is generated in accordance with a difficulty level.

22. A computer program product comprising:
a non-transitory computer readable medium;
a first program instruction for receiving a rule;
a second program instruction for dynamically generating a graph representing a question, the graph comprising at least one node, the at least one node associated with a rule having at least one variable; and
a third program instruction for sampling a value from the value domain for the at least one variable; and
a fourth program instruction for synthesizing a textual representation of the graph,
wherein said first, second, third and fourth program instructions are stored on said non-transitory computer readable medium.
